(19) United States
(12) Patent Application Publication
(10) Pub. No.: US 2008/0059902 A1
(43) Pub. Date: Mar. 6, 2008

(54) Operation system

(75) Inventor: Makoto Nakashima, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/896,334

(22) Filed: Aug. 31, 2007

(30) Foreign Application Priority Data
Sep. 5, 2006 (JP) JP 2006-240730

(51) Int. Cl. G06F 3/048

(52) U.S. Cl. 715/783

(57) ABSTRACT

Each time an execution of a function is demanded in each functional operation window at the undermost layer, a frequency of uses for the each functional operation window is recorded. In an operation menu window at each layer, when a selection operation for selecting a certain item is continued equal to or longer than a predetermined time, a display window is controlled to change to a functional operation window having the frequency of uses highest among functional operation windows selectable through the selected certain item based on the stored frequencies of uses. Thus, the functional operation window frequently used can be reached directly from the higher layered operation menu window, thereby simplifying the user's operation effectively.

### CROSS REFERENCE TO RELATED APPLICATION

This application is based on and incorporates herein by reference Japanese Patent Application No. 2006-240730 filed on Sep. 5, 2006.

### FIELD OF THE INVENTION

The present invention relates to an operation system in which display of operation menus is multi-layered.

### BACKGROUND OF THE INVENTION

The various proposals to facilitate the user's input operation are made to a conventional operation system in which display of operation menus is multi-layered. For example, Patent document 1 discloses an operation system including a control device, which receives as an operation instruction an input operation via an operation panel or multiple operation switches in the operation panel, and which is operated based on the received operation instruction.

The operation panel includes the following: a mode switch which allows switching of a mode to a storing mode or releasing of the storing mode; an execution switch; a storage unit; and a processing unit. The processing unit stores in the storage unit an operation procedure of consecutive operations of an operation switch undergone in the storing mode, and serially transmits to the control device an operation instruction based on the stored operation procedure of the operation switch when the execution switch is pressed while the storing mode is released.

Here, in the above-mentioned operation system, a user needs to determine whether to store an operation procedure. When storing the operation procedure is determined, the user then needs to change the mode to the storing mode using the mode switch in the operation system.

Furthermore, when the user wants to change the operation procedure for executing a different function, the mode is switched again to the storing mode and consecutive operations intended to be stored are needed to be actually performed.

Thus, the conventional operation system requires operations for storing an operation procedure and repeated operations for changing the operation procedure when the change is needed, thereby not sufficiently relieving the user from the workload in the operations.

Patent document 1: JP-2002-2416 A

### SUMMARY OF THE INVENTION

The present invention is made in consideration of such an issue. It is an object to provide an operation system which can simplify operations by the user, while eliminating necessary operations for storing an operation procedure.

To achieve the above object, according to an example of the present invention, an operation system is provided as follows. A multi-layered operation menu system is included to have (i) functional operation windows at an undermost layer and (ii) operation menu windows at layers higher than the undermost layer, wherein a repetitive selection operation to select each intended item in each operation menu window is applied in order from a higher layered operation menu window to a lower layered operation menu window so as to reach a functional operation window for executing an intended function. A storing unit is included to store a frequency of uses of each functional operation window. A demand unit is included to specify one item and demand a direct movement to an undermost layered functional operation window based on an operation by a user when a certain operation menu window is displayed. A display control unit is included to select a certain functional operation window having a highest frequency of uses among functional operation windows selectable through the item specified by the demand unit based on the stored frequencies of uses and to change the displayed certain operation menu window to the selected certain functional operation window when the direct movement is demanded.

### BRIEF DESCRIPTION OF THE DRAWINGS

The above and other objects, features, and advantages of the present invention will become more apparent from the following detailed description made with reference to the accompanying drawings. In the drawings:

FIG. 1 shows a block diagram illustrating a configuration of a navigation apparatus according to an embodiment of the present invention;

FIG. 2 is a view illustrating an example of a menu window layered in the uppermost in the navigation apparatus;

FIG. 3 is a flow chart of a process for displaying menu windows in the navigation apparatus; and

FIG. 4 is a diagram for explaining a process for displaying menu windows in the navigation apparatus.

### DETAILED DESCRIPTION OF THE PREFERRED EMBODIMENTS

Hereafter, an operation system according to an embodiment of the present invention will be explained with reference to drawings. This embodiment is applied to an operation system provided in a navigation apparatus mounted in a subject vehicle. The operation system may be, however, applied to other apparatuses without limited to the navigation apparatus.

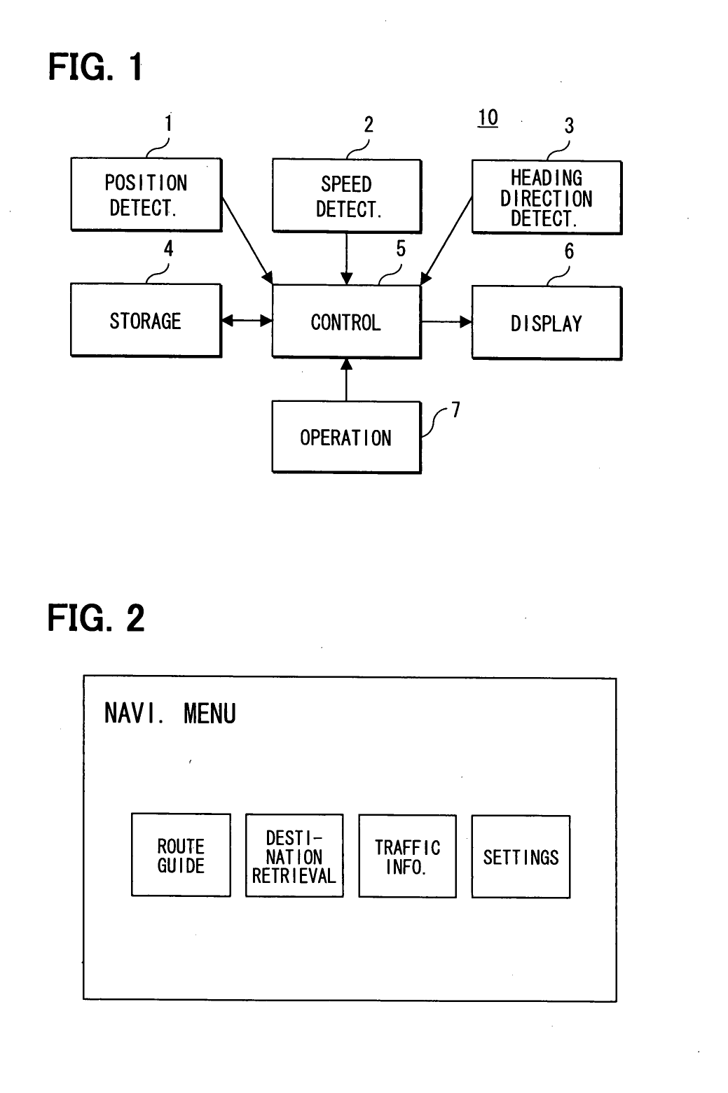

FIG. 1 shows a block diagram illustrating a configuration of the navigation apparatus. The navigation apparatus 10 includes the following: a control device 5, a position detection device 1, a speed detection device 2, a heading direction detection device 3, a storage device 4 as a storing unit, a display device 6, and an operation device 7. Furthermore, the navigation apparatus 10 may be equipped with an audio output device for guiding various kinds of information by audio.

The control device 5 is a usual computer having a known CPU, ROM, RAM, I/O, and bus line connecting the preceding components. The ROM stores a program for controlling various kinds of processes executed in the navigation apparatus 10, and the CPU etc. executes predetermined data processing based on the program.

The position detection device 1 includes a GPS receiver for GPS (Global Positioning System) which detects positions of the vehicle based on electric waves from satellites, and a GPS antenna.

This position detection device 1 periodically transmits, to the control device 5, data on the vehicle positions from the radio navigation.

The speed detection device 2 includes a pickup coil and a rotor rotating at a speed based on a speed of the subject vehicle to thereby detect the speed of the vehicle. The detected speed data are transmitted to the control device 5. The heading direction detection device 3 includes well-known sensors or the like such as a geomagnetic sensor and a gyroscope to thereby detect a heading direction (i.e., traveling direction) of the subject vehicle as an absolute or relative orientation. The detected orientation data are transmitted to the control device 5. The control device 5 computes a vehicle position (i.e., a current position of the vehicle) with dead-reckoning navigation based on detection results from the speed detection device 2 and heading direction detection device 3. The control device 5 consequently obtains a vehicle position and heading direction based on the vehicle positions from the autonomous navigation and radio navigation.

The storage device 4 includes a storage medium such as CD-ROM, DVD-ROM, and HDD to store drawing data for drawing maps and facility data for retrieving facilities. In addition, the facility data include the various data such as facility names, categories of facilities, addresses, telephone numbers, postal code numbers, and coordinates of facilities. Furthermore, the storage device 4 has rewritable memory to store a frequency of uses for each functional operation window layered at the lowest or undermost in the hierarchy (to be explained later).

The display device 6 is a liquid crystal display, for example. The display device 6 displays, on its screen, a map display window and an operation menu window for executing each function of the navigation apparatus 10. The map display window illustrates, e.g., (i) a peripheral map of the current position of the vehicle generated from the drawing data in the storage device 4, and (ii) a vehicle position mark indicating the current position and heading direction of the vehicle.

The operation device 7 uses a mechanical panel switch or a touch switch (touch-sensitive switch) integrated with the display device 6, for example, and is used for (i) various inputs such as character inputs and selections of menu items, and (ii) scroll operation of maps displayed on the screen of the display device 6.

Navigation apparatus 10 has a variety of functions as follows: a destination retrieval function to retrieve a destination based on name, address, telephone number, etc.; a route guide function to retrieve an optimal route from a departure point (or current position etc.) to the retrieved destination, display the retrieved route on the screen, and announces an audio assist to indicate a heading direction, thereby guiding the vehicle to the destination; a traffic information provision function to display traffic information, such as traffic congestions and constructions; and several setting functions to execute the various setups, e.g., for screen setting in the display device 6.

The user selects display items according to the operation menu window, or inputs required information; thereby, a certain function desired or intended by the user can be executed on a certain condition. That is, operation menu windows are layered as a multi-layered operation menu system in the hierarchy in consideration of the conspicuousness and operability in the window display. When the user executes selection operation to select a certain item in the operation menu window at a higher layer (i.e., a higher-layered operation menu window), the display window is changed to the operation menu window, which is one layer lower than the higher-layer operation menu window and corresponding to the selected certain item. A selection operation to select a desired or intended item is successively repeated in each hierarchical operation menu window; thereby, a functional operation window at the undermost layer appears for executing a target function.

An example of the uppermost menu window is shown in FIG. 2. The operation system of the embodiment is applied to the in-vehicle navigation apparatus; therefore, items in the major classification of the various executable functions in the navigation apparatus are displayed in the uppermost menu window. When a certain menu item displayed on the menu window in FIG. 2 is selected, the menu window, which is one layer lowered and corresponding to the selected menu item, is displayed. The functional operation window at the undermost layer appears finally after a repetitive selection operation to select each item (i.e., repeating such selection operations), accordingly. This functional operation window means a screen window which can demand an execution of a function based on the condition (i.e., execution condition) specified by the user's selection or input; therefore, the selection and input for specifying the execution condition for the function are mainly made via the functional operation window. Alternatively, part or all of the selection or input for specifying the execution condition may be made in other operation menu windows before reaching the functional operation window.

For example, with reference to FIG. 2, the destination retrieval item is selected in the menu window (i.e., NAVI. MENU). The following menu window at the next lower layer then appears. The menu window includes multiple items for indicating retrieval methods (names, categories, addresses, postal code numbers, telephone numbers, etc.). When the “names” is selected in these items, a character input window (e.g., alphabetical input window) appears as a functional operation window; thereby, an intended name is then inputted using alphabetical keys. In this case, in the functional operation window, inputs are performed for specifying the execution condition for the function.

In contrast, when the item of “addresses” is selected in the multiple items indicating retrieval methods, a selection menu appears for selecting prefectures. When any one of the prefectures intended as a destination is selected, selection menus for selecting city levels (city, town, village), area levels, and block levels, etc. appear in order based on the selection operation in the higher layered menu. Then, the instruction switch which demands an execution of displaying a map corresponding to the selected address is operated. When the map is displayed, the final destination is indicated on the displayed map. In this case, the window used for demanding and determining the final destination on the displayed map corresponds to the functional operation window, and selections for specifying execution conditions are performed also in the menu windows to narrow down the addresses.

As explained above, the destination retrieval function has multiple items indicating destination retrieval methods; further, selections and inputs are repeatedly performed for selecting conditions for narrowing down destinations. Therefore menu windows are often prepared at many layers. Conventionally, even if the same destination as that retrieved in the past is retrieved, the same selections and inputs need to be repeatedly performed from the uppermost layer to the undermost layer of the functional operation window, therefore needing the user's operation load.

To that end, the navigation apparatus 10 of this embodiment stores the frequency of uses of each functional operation window at the undermost layer. That is, an operation or depression for selecting a certain item is continued equal to or longer than a predetermined time in an operation menu window at each layer. In this case, the display window is controlled based on the stored frequencies of uses of the undermost layered functional operation windows, to directly move to the functional operation window at the undermost layer with the highest frequency of uses among those of the functional operation windows selectable through the selected item. Thus, the functional operation window used frequently can be reached directly from the higher layered operation menu window, thereby simplifying the user's operation effectively.

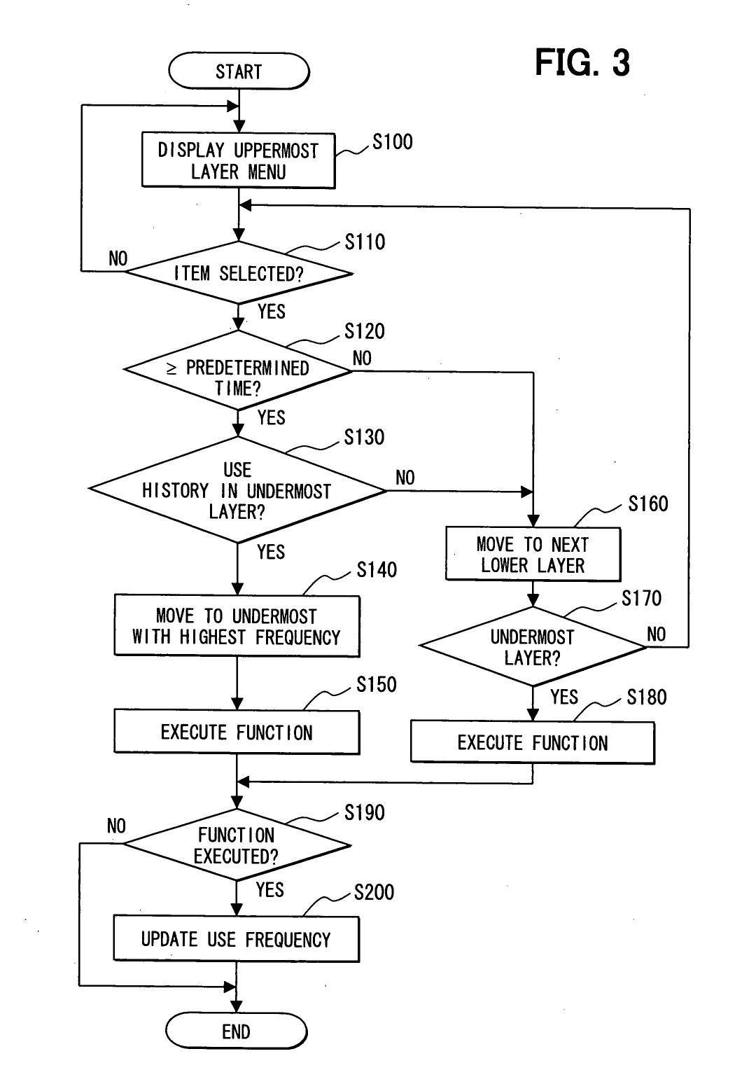

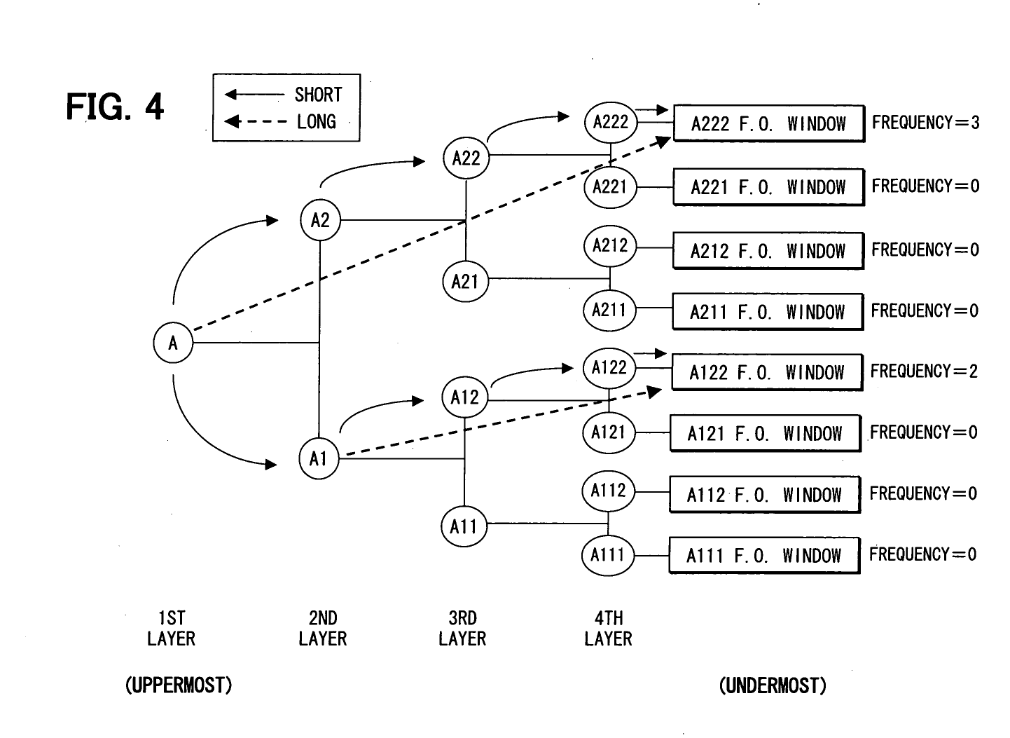

With reference to FIGS. 3, 4, a process for displaying a menu window in the navigation apparatus 10 will be explained below.

With the start of the process for displaying the menu window, at Step S100, the uppermost layered menu window in the navigation apparatus 10 appears. At next Step S110, it is determined whether an intended item is selected by the user in the uppermost layered menu window. Here, when the touch switch is used, a selection operation of selecting an item is performed by touching a display position of the intended item. When the panel switch surrounding the display screen is used, a selection operation is performed by pressing a determining switch while the cursor is located in the intended item.

At Step S110, when the selection operation is determined, Step S120 is then performed. At Step S120, it is determined whether the selection operation by the user is corresponding to a long depression that a selection operation is continued equal to or longer than a predetermined time. In the embodiment, a short depression that a selection operation is continued shorter than the predetermined time is regarded as a simple selection operation for simply selecting an item. In contrast, the long depression of the selection operation is regarded as a demand for a direct movement (or a transit instruction), which changes the display window directly to the undermost layered functional operation menu without displaying the intermediate menu window(s). Thus, Step S120 executed by the control device 5 may function as a demand means or unit to specify one item and demand a direct movement to an undermost layered functional operation window.

At Step S120, when the selection operation is determined to be corresponding to the long depression, Step S130 is then performed. Here, it is determined whether the update history of the frequencies of uses, i.e., the use history, is stored with respect to the undermost layered functional operation window which can be selected through the item to which the long depression of the selection operation is applied.

Here, the technique of storing the update history of the frequencies of uses for undermost layered functional operation windows is explained with reference to FIG. 4. FIG. 4 illustrates how to update and store the frequency of uses of each undermost layered functional operation window belonging to the major classification A among the multiple major classifications A, B, and C.

FIG. 4 illustrates an example of the frequency of uses for each functional operation window. That is, a corresponding function is executed twice by the undermost layered functional operation window A122, while a corresponding function is executed three times by the undermost layered functional operation window A222.

In addition, for instance, the execution of the function by the functional operation window A222 is completed as follows: the functional operation window A222 is displayed; the selection and/or input are performed for specifying the execution condition of the function in the functional operation window A222; and the instruction switch is operated to demand the execution of the function. To display the undermost layered functional operation window A222, as indicated in FIG. 4, it is only needed to select in order each corresponding item (first layer: A, second layer: A2, third layer: A22, fourth layer: A222) in each layer by the short depression of the selection operation. Alternatively, once an execution of the function is completed using the functional operation window A222 to thereby update to increment the frequency of uses, the display window directly can move directly to the functional operation window A222 from the higher layered menu window based on the updated frequency of uses.

Thus, when the undermost layered functional display window is displayed and execution of the function is demanded by the user's operation therein, the corresponding frequency of uses is updated to be incremented. In other words, when the user cancels execution of the function via the functional operation window in the middle of operation with the undermost layered functional operation window displayed, the frequency of uses is not updated or incremented. Therefore, the frequency of uses for each functional operation window can be recorded to meet the actual uses of the user.

When it is determined at Step S130 that the use history is stored with respect to the undermost layered functional operation window which can be selected through the selected item, Step S140 is then performed. At Step S140 the functional operation window with the frequency of uses highest in those of the undermost layered functional operation windows selectable through the selected item is selected to appear directly without displaying the intermediate menu window(s). Thereby, the user's selection operation becomes unnecessary in the menu window(s) which is not displayed, thereby relieving the user from operation load. Thus, Step S140 executed by the control device 5 may function as a display control means or unit to select a certain functional operation window having a highest frequency of uses among functional operation windows selectable through the item specified by the demand unit based on the stored frequencies of uses and to change the displayed certain operation menu window to the selected certain functional operation window when the direct movement is demanded.

For instance, in FIG. 4, a long depression of the selection operation is applied to the first layered item A, the second layered item A2, or the third layered item A22. In this case, the display window moves directly to the undermost layered functional operation window A222 based on the stored frequencies of uses.

Further, for instance, a long depression of the selection operation is applied to the second layered item A1 or the third layered item A12. In this case, the display window moves directly to the undermost layered functional operation window A122 based on the stored frequencies of uses.

This is because the functional operation window A222 has the frequency of uses highest in the functional operation windows selectable through the first layered item A, the second layered item A2, or the third layered item A22. Further, this is because the functional operation window A122 has the frequency of uses highest in the functional operation windows selectable through the second layered item A1 or the third layered item A12.

The functional operation window with the high frequency of uses has a high probability the user will repeatedly use it in future. As explicitly explained in the embodiment, the higher frequency of uses the undermost layered functional operation window has can be reached directly from the higher layered menu window. This allows the user to view the more frequently used functional operation window through the more simple operation.

At Step S150, the input process for specifying the execution condition of the function and/or the execution of the function based on the user's instruction are performed in the functional operation window.

In contrast, when the selection operation is determined to be shorter than the predetermined time at Step S120 or when the use history is determined not to be stored at Step S130, Step S160 is performed. At Step S160, the display window is changed to the next lower layered one based on the selected item. This is because a use history is not available for any functional operation window selectable from the selected item to which the long depression is applied to be thereby unable to determine which functional operation window should be displayed.

At Step S170, it is determined whether the currently displayed window is the undermost layered functional operation window or not. When determined not to be the undermost layered, Step S110 and subsequent steps are repeated. In contrast, when determined to be the undermost layered, Step S180 is performed. Here, similarly at Step S150, the input process for specifying the execution condition of the function and/or the execution of the function based on the user's instruction are performed in the functional operation window.

After Step S150 or S180, Step S190 is performed. At Step S190, it is determined whether the function is actually executed using the functional operation window. When determined to be actually executed at Step S190, Step S200 is performed. Here, the frequency of uses of the functional operation window corresponding to the executed function is incremented and the stored content is updated. Therefore, even when the operation in the functional operation window is halfway stopped, the frequency of uses is not updated incorrectly.

Although the embodiment mentioned above is a desirable embodiment of the present invention, the present invention can be modified within an area not deviating from the scope thereof without being restricted.

For example, the above example explains the case where the frequency of uses of each functional operation window differs from each other, as shown in FIG. 4. Multiple functional operation windows may have the same frequency of uses highest in the undermost layer. For instance, in FIG. 4, if the frequency of uses of the functional operation window A222 is twice, it becomes the same as that of the frequency of uses of the functional operation window A122. When the long depression of the selection operation is applied to the item A in the first layer, either the functional operation window A122 or functional operation window A222 can be selectable through the item A. It is therefore preferable to prepare the configuration for determining whether to select one of the functional operation windows when the long depression is applied.

An example of this configuration is explained below. When the control device 5 updates the frequency of uses of each functional operation window stored by the storage device 4, information on clock time for updating is also stored in addition. The long depression is performed and the frequencies of uses of multiple undermost layered functional operation windows corresponding to the selection operation are identical to each other. In this case, the control device 5 is configured to select the functional operation window having the most recently updated frequency of uses among the multiple functional operation windows. This allows the user to select the functional operation window having the highest probability to be used, even if the user's uses of the functional operation windows change on the basis of time.

Moreover, in order to select one of the multiple functional operation windows having the same frequency of uses, another configuration can be adopted. That is, the control device 5 displays the list (using character or icon) of the multiple functional operation windows when the multiple functional operation windows having the same frequency of uses coexist. The user can select one of those functional operation windows from the displayed list. This allows the functional operation window preferred by the user to be displayed certainly.

Moreover, the control device 5 can be configured to display the information indicating that the highest frequency of uses of the functional operation window changes, when it is determines based on the frequency of uses of each undermost layered functional operation window stored by the storage device 4. For instance, the information may be displayed which indicates the functional operation window newly having the highest frequency of uses. All or part of the functional operation windows may be displayed in order of the frequencies of uses by using characters or icons. Thereby, the user can recognize in advance which functional operation window will be displayed when the long depression is applied to each item in the menu window.

Further, the information may be displayed on which functional operation window appears when the user specifies a certain item in the menu window with the long depression of the selection operation. Thereby, the user can recognize in advance which functional operation window will be displayed when the long depression is applied to each item in the menu window.

In the embodiment mentioned above, the long depression in which the selection operation for selecting an item is continued equal to or longer than the predetermined time is used as the instruction operation (i.e., a demand for direct movement) to demand direct movement from the present display window to the undermost layered functional operation window while omitting the display of the intermediate menu window(s). This can eliminate the need of the switch for exclusive use for executing the above instruction operation. However, of course, the exclusive switch can be provided for exclusive use for executing the instruction operation. In this case, the user may specify the displayed item with the cursor or the like located in the displayed item to operate the exclusive switch.

In addition, in the embodiment, the input information may be present which is inputted in each operation menu window at each layer and/or undermost layered functional operation window. Here, the input information can be also stored. If the input information is stored, the stored input information can be reflected on the functional operation window when direct movement thereto by bypassing the intermediate menu window(s) is instructed with the long depression. This can eliminate the need of inputting information when executing the function having executed in the past on the condition based on the same input information stored. Here, the above step executed by the control device 5 may function as an input reflection means or unit.

Here, it is desirable for the user to be able to select whether the input information be reflected on the functional operation window. This is because the user may want the execution of the same function with the condition different from the previous condition under which the same function was previously executed. For the user to be able to select whether the stored input information be reflected, for instance, it can be designed that the user is able to select beforehand one of reflection mode and non-reflection mode. When the user selects the reflection mode, the input information can be reflected while the display window changes to the functional operation window. Alternatively, a switch may be provided for the user to demand reflection of the input information when the display window changes to the functional operation window.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

Aspects of the subject matter described herein are set out in the following clauses.

As a first aspect, an operation system is provided as follows. A multi-layered operation menu system is included to have (i) functional operation windows at an undermost layer and (ii) operation menu windows at layers higher than the undermost layer, wherein a repetitive selection operation to select each intended item in each operation menu window is applied in order from a higher layered operation menu window to a lower layered operation menu window so as to reach a functional operation window for executing an intended function. A storing unit is included to store a frequency of uses of each functional operation window. A demand unit is included to specify one item and demand a direct movement to an undermost layered functional operation window based on an operation by a user when a certain operation menu window is displayed. A display control unit is included to select a certain functional operation window having a highest frequency of uses among functional operation windows selectable through the item specified by the demand unit based on the stored frequencies of uses and to change the displayed certain operation menu window to the selected certain functional operation window when the direct movement is demanded.

In the above configuration, an attention is paid to the following: functions demanded by users via functional operation windows layered in the undermost are deviated based on the individual users' tastes, needs, etc.; and the frequently used functional operation window has a high probability the user repeatedly uses.

Thus, the storing unit stores the frequency of uses of each functional operation window at the undermost layer. When the direct movement is demanded by the demand unit, the functional operation window having the frequency of uses highest among the undermost layered functional operation windows selectable through the selected item is selected based on the stored frequencies of uses of the undermost layered functional operation windows, to thereby appear directly without displaying the intermediate menu window(s). Thus, the functional operation window frequently used can be reached directly from the higher layered operation menu window, thereby simplifying the user's operation effectively.

As a second aspect, when the certain functional operation window is displayed and execution of a function is demanded in the certain functional operation window through an operation by the user, the storing unit may update a corresponding frequency of uses stored.

Thus, when the user actually demands an execution of the function, the frequency of uses of the corresponding undermost layered functional operation window is updated. In other words, since the frequency of uses is not updated by the undermost layered functional operation window being only displayed, the storing unit can store the frequency of uses meeting the use state of each function by the user.

As a third aspect, the direct movement demanded by the demand unit may be performed when the user continues a selection operation to select an intended item equal to or longer than a predetermined time. This can eliminate the need of a switch for exclusive use for demanding the direct movement.

As a fourth aspect, when no update history is present with respect to a frequency of uses of each functional operation window selectable through the specified item even if the direct movement is demanded by the demand unit, the display control unit may change the displayed certain operation menu window to a lower layer operation menu window corresponding to the specified item. This is because it is unable to determine which functional operation window should be displayed when an update history for the frequency of uses is not available for any functional operation window selectable through the selected item.

As a fifth aspect, the storing unit may store clock time information on a time when a frequency of uses of each functional operation window is updated. In a case that more than one functional operation window, which has an identical frequency of uses highest among functional operation windows selectable through the specified item, is present when the direct movement is demanded by the demand unit, the display control unit selects a functional operation window, which has the identical frequency of uses updated most recently among the more than one functional operation window, and changes the displayed certain operation menu window to the selected functional operation window.

Thus, when there are multiple functional operation windows having the same highest frequency of uses, the functional operation window having the frequency of uses most recently updated can be selected based on the stored clock time information. This allows the selection of the functional operation window having the highest probability that the user selects it, even if the user's uses of the functional operation windows changes on the basis of time.

As a sixth aspect, in a case that more than one functional operation window, which has an identical frequency of uses highest among functional operation windows selectable through the specified item, is present when the direct movement is demanded by the demand unit, the display control unit may display a window for the user to select a functional operation window among the more than one functional operation window. When one functional operation window is selected, the display control unit may change the displayed certain operation menu window to the selected one functional operation window.

This allows the functional operation window preferred by the user to be displayed certainly.

As a seventh aspect, when it is determined that a functional operation window having a highest frequency of uses changes based on the stored frequencies of uses, the display control unit may display information indicating that a functional operation window having a highest frequency of uses changes. Thereby, the user can recognize in advance which functional operation window will be displayed when the user performs an operation to demand the direct movement.

As an eighth aspect, in a case that a direct movement to an undermost layered functional operation window is demanded when one item is specified in the certain operation menu window by the user, the display control unit displays information about a functional operation window to which the direct movement is demanded. Thereby, the user can recognize in advance which functional operation window will be displayed when the user performs an operation to demand the direct movement.

As a ninth aspect, an input reflection unit may be included to reflect, on an undermost layered functional operation window, input information, which is inputted in each operation menu window at each layer and a functional operation window and stored in the storing unit when a displayed window is changed to the undermost layered functional operation window based on a demand by the demand unit. This can eliminate the need of inputting information when executing the function having executed in the previous time on the condition based on the same input information stored.

As a tenth aspect, the user may be allowed to select whether the input information be reflected on the functional operation window. This is because the user may want the execution of the same function with the condition different from the previous condition under which the same function was previously executed. For the user to be able to select whether the stored input information be reflected, for instance, the user can be allowed to select beforehand one of reflection mode and non-reflection mode. When reflection mode is selected, the input information is reflected while changing to the functional operation window. Alternatively, when it changes to the functional operation window, a switch may be provided for the user to demand reflection of the input information.

It will be obvious to those skilled in the art that various changes may be made in the above-described embodiments of the present invention. However, the scope of the present invention should be determined by the following claims.

What is claimed is:

1. An operation system comprising:
a multi-layered operation menu system including functional operation windows at an undermost layer and operation menu windows at layers higher than the undermost layer, wherein a repetitive selection operation to select each intended item in each operation menu window is applied in order from a higher layered operation menu window to a lower layered operation menu window so as to reach a functional operation window for executing an intended function;
a storing unit to store a frequency of uses of each functional operation window;
a demand unit to specify one item and demand a direct movement to an undermost layered functional operation window based on an operation by a user when a certain operation menu window is displayed; and
a display control unit to select a certain functional operation window having a highest frequency of uses among functional operation windows selectable through the item specified by the demand unit based on the stored frequencies of uses and to change the displayed certain operation menu window to the selected certain functional operation window when the direct movement is demanded.

2. The operation system of claim 1, wherein
when the certain functional operation window is displayed and execution of a function is demanded in the certain functional operation window through an operation by the user, the storing unit updates a corresponding frequency of uses stored.

3. The operation system of claim 2, wherein
the direct movement demanded by the demand unit is performed when the user continues a selection operation to select an intended item equal to or longer than a predetermined time.

4. The operation system of claim 1, wherein
when no update history is present with respect to a frequency of uses of each functional operation window selectable through the specified item even if the direct movement is demanded by the demand unit, the display control unit changes the displayed certain operation menu window to a lower layer operation menu window corresponding to the specified item.

5. The operation system of claim 1, wherein:
the storing unit stores clock time information on a time when a frequency of uses of each functional operation window is updated;
in a case that more than one functional operation window, which has an identical frequency of uses highest among functional operation windows selectable through the specified item, is present when the direct movement is demanded by the demand unit, the display control unit selects a functional operation window, which has the identical frequency of uses updated most recently among the more than one functional operation window, and changes the displayed certain operation menu window to the selected functional operation window.

6. The operation system of claim 1, wherein:
in a case that more than one functional operation window, which has an identical frequency of uses highest among functional operation windows selectable through the specified item, is present when the direct movement is demanded by the demand unit, the display control unit displays a window for the user to select a functional operation window among the more than one functional operation window; and
when one functional operation window is selected, the display control unit changes the displayed certain operation menu window to the selected one functional operation window.

7. The operation system of claim 1, wherein
when it is determined that a functional operation window having a highest frequency of uses changes based on the stored frequencies of uses, the display control unit displays information indicating that a functional operation window having a highest frequency of uses changes.

8. The operation system of claim 1, wherein
in a case that a direct movement to an undermost layered functional operation window is demanded when one item is specified in the certain operation menu window by the user, the display control unit displays information about a functional operation window to which the direct movement is demanded.

9. The operation system of claim 1, further comprising:
an input reflection unit to reflect, on an undermost layered functional operation window, input information, which is inputted in each operation menu window at each layer and a functional operation window and stored in the storing unit when a displayed window is changed to the undermost layered functional operation window based on a demand by the demand unit.

10. The operation system of claim 9, wherein
the user is allowed to select whether the input information be reflected on the functional operation window.
